(19) United States
(12) Patent Application Publication
(10) Pub. No.: US 2007/0133346 A1
(43) Pub. Date: Jun. 14, 2007

(54) Mixing of chemicals into a thin stock pipe

(76) Inventors: Tommy Jacobson, Helsinki (FI); Martti Latva, Rusko (FI); Mikail Abacka, Kauniainen (FI)

Correspondence Address: NALCO COMPANY, 1601 W. DIEHL ROAD, NAPERVILLE, IL, 60563-1198, US

(21) Appl. No.: 11/302,861

(22) Filed: Dec. 14, 2005

(51) Int. Cl. B01F 15/02

(52) U.S. Cl. 366/160.2; 366/179.1

(57) ABSTRACT

A method of mixing chemical into a process stream of thin stock pipe in a papermaking process is disclosed and claimed. Chemical is added to a portion of a process stream drawn from the thin stock pipe. This mixture is then fed to the thin stock pipe to mix with said process stream.

### FIELD OF THE INVENTION

This disclosure pertains to a method of mixing chemicals into a process stream of a thin stock pipe of a papermaking process.

### BACKGROUND OF THE INVENTION

Conventional systems for mixing chemicals into a process stream in a thin stock pipe of a papermaking process involve the direct addition of chemical as a suspension into the thin stock pipe. The chemical, via this mode of addition, does not penetrate and dilute into the thin stock pipe flow immediately, but often stays in the boundary layer of the thin stock pipe flow due to the small volumetric flow of the chemical. Local overdose in the boundary layer occurs and the chemical is slowly diluted by turbulent diffusion.

The problems associated with these systems are severe local flocculation and deactivation of the chemical. Hence, when fully mixed conditions are finally reached, a part of the chemical may be inactive and the flock distribution of the process stream, for example, the thin stock, is very heterogeneous. The need for an improved method of mixing chemical into a process stream in a thin stock pipe of a papermaking process is thus needed.

### SUMMARY OF THE INVENTION

The present invention provides for a method of mixing one or more chemicals into a process stream in a thin stock pipe of a papermaking process comprising the steps of: running said papermaking process so that said process stream flows through said thin stock pipe; drawing a portion of a process stream from said thin stock pipe; adding said chemicals to said portion of said process stream so that a mixture forms; and feeding said mixture into said thin stock pipe so that said mixture mixes with said process stream.

The present invention also provides for a method of mixing one or more chemicals into a process stream in a thin stock pipe of a papermaking process comprising the steps of: arranging one or more side streams on the periphery of said thin stock pipe that are located between a series of inlets and outlets that are in communication with said thin stock pipe, wherein said side streams have one or more openings that allow for said chemicals to be added to said side streams; providing one or more apparatuses for feeding said chemicals wherein said apparatuses are in communication with said openings of said side streams; running said papermaking process so that said process stream flows through said thin stock pipe; drawing a portion of said process stream into said side streams from said inlets of said thin stock pipe; adding said chemicals to said side streams by said apparatuses so that a mixture forms; and feeding said mixture into said thin stock pipe through said outlets, wherein said mixture mixes with said process stream.

### BRIEF DESCRIPTION OF THE DRAWINGS

FIG. 1 is a schematic diagram illustrating the operation of an apparatus for mixing a chemical into a process stream in a thin stock pipe in accordance with the present invention.

### DETAILED DESCRIPTION OF THE INVENTION

“Papermaking process” means a method of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art.

“Thin stock pipe” means a pipeline between a machine chest and headbox in a papermaking process.

As described above, the invention pertains to a method of mixing one or more chemicals into a process stream in a thin stock pipe of a papermaking process. In one embodiment, the process stream contains a thin stock.

The amount of chemical and type of chemical added to the side stream is operator dependent. Protocols for employing certain chemicals in particular amounts are well known to those of ordinary skill in the papermaking art. A person of ordinary skill in the art would look at such factors, which include, but are not limited to, the following: the type of papermaking machine and the end product desired. In one embodiment, the chemicals added to the drawn portion of the process stream are selected from the group consisting of: biocides, strength agents, brightening agents, colors, fillers, sizing agents, retention aids, drainage aids, flocculants, washing aids, defoamers, dispersing agents, nanoparticles, microparticles, fixatives, coagulants, and a combination thereof. In yet a further embodiment, the chemicals are added to the portion of the process stream drawn from the thin stock pipe or side streams on a one-time basis, a continuous basis, a pre-set basis, or on an intermittent basis.

In another embodiment, the chemicals are added to or side stream or said portion of the process stream or side streams by a carrier selected from the group consisting of: clean water; thin stock; clear filtrate; and white water.

In another embodiment, one or more apparatuses for feeding chemicals are utilized to add one or more chemicals to the portion of the process stream drawn from the thin stock pipe or side streams. In one embodiment, said apparatuses are one or more dosage pumps. The location of an apparatus for feeding chemicals can be at any point along the side stream. In yet another embodiment, the apparatuses for feeding chemicals are located proximate to the outlet of the side streams.

The present invention will be further described in the following example. The example is not intended to limit the invention prescribed by the appended claims.

### EXAMPLE 1

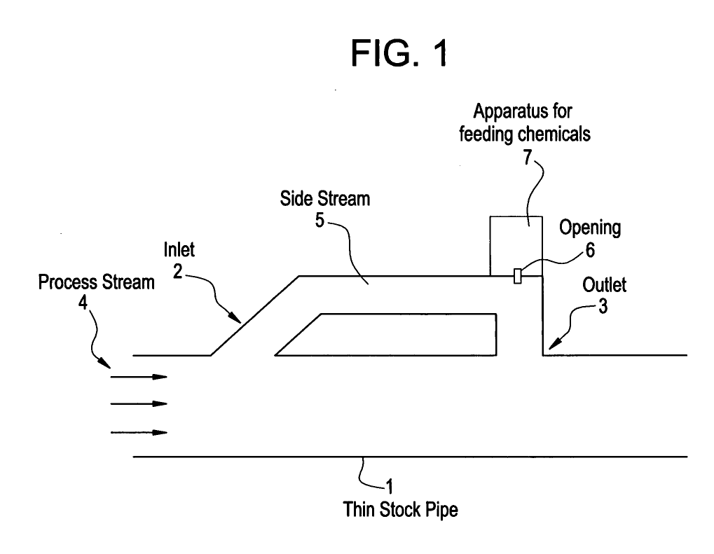

Referring to FIG. 1, a thin stock pipe (1) was modified to have a side stream (5) that is located between an inlet (2) and an outlet (3) that are both in communication with the thin stock pipe (1). The side stream has been set up to have an opening (6) that allows for the addition of one or more chemicals to the thin stock pipe (1), as well as an apparatus for feeding chemicals (7) that is in communication with this opening (6) and, which serves to facilitate the addition of chemicals to the side stream (5). A portion of the process stream (4) from the thin stock pipe (1) is drawn into the side stream (5). Chemicals were then added to the side stream (5) by the apparatus for feeding chemicals (7), which can dose chemicals on a desired basis, for example, a one-time basis, continuous basis, a pre-set basis, or on an intermittent basis. As a result of this step, a mixture was formed. This mixture was subsequently mixed with process stream (4) of the thin stock pipe (1).

We claim:

1. A method of mixing one or more chemicals into a process stream in a thin stock pipe of a papermaking process comprising the steps of:
a. running said papermaking process so that said process stream flows through said thin stock pipe;
b. drawing a portion of said process stream from said thin stock pipe;
c. adding said chemicals to said portion of said process stream so that a mixture forms; and
d. feeding said mixture into said thin stock pipe so that said mixture mixes with said process stream.

2. The method of claim 1, wherein said chemicals are added to said portion by one or more apparatuses for feeding chemicals.

3. The method of claim 1, wherein said chemicals are added to said portion on a one time basis, a continuous basis, an intermittent basis, or on a pre-set basis.

4. The method of claim 1, wherein said chemicals are selected from the group consisting of: biocides, strength agents, brightening agents, colors, fillers, sizing agents, retention aids, drainage aids, flocculants, washing aids, defoamers, dispersing agents, nanoparticles, microparticles, fixatives, coagulants, and a combination thereof.

5. The method of claim 1, wherein said chemicals are added to said portion by a carrier selected from the group consisting of: clean water; thin stock; clear filtrate; and white water.

6. The method of claim 1, wherein said process stream contains a thin stock.

7. The method of claim 2, wherein said apparatuses are one or more dosage pumps.

8. A method of mixing one or more chemicals into a process stream in a thin stock pipe of a papermaking process comprising the steps of:
a. arranging one or more side streams on the periphery of said thin stock pipe that are located between a series of inlets and outlets that are in communication with said thin stock pipe, wherein said side stream has one or more openings that allow for said chemicals to be added to said side streams;
b. providing one or more apparatuses for feeding chemicals, wherein said apparatuses are in communication with said openings of said side streams;
c. running said papermaking process so that said process stream flows through said thin stock pipe;
d. drawing a portion of said process stream into said side streams from said inlets of said thin stock pipe;
e. adding said chemicals to said side streams by said apparatuses so that a mixture forms; and
f. feeding said mixture into said thin stock pipe through said outlets, wherein said mixture mixes with said process stream.

9. The method of claim 8, wherein said apparatuses are proximate to said outlets of said side streams.

10. The method of claim 8, wherein said chemicals are added to said side streams on a one time basis, a continuous basis, an intermittent basis, or on a pre-set basis.

11. The method of claim 8, wherein said chemicals are selected from the group consisting of: biocides, strength agents, brightening agents, colors, fillers, sizing agents, retention aids, drainage aids, flocculants, washing aids, defoamers, dispersing agents, nanoparticles, microparticles, fixatives, coagulants, and a combination thereof.

12. The method of claim 8, wherein said chemicals are added to said side streams by a carrier selected from the group consisting of: clean water; thin stock; clear filtrate; and white water.

13. The method of claim 8, wherein said process stream contains a thin stock.

14. The method of claim 8, wherein said apparatuses are one or more dosage pumps.
